(19) United States
(12) Patent Application Publication
(10) Pub. No.: US 2017/0180494 A1
(43) Pub. Date: Jun. 22, 2017

(54) METHOD AND SYSTEM FOR DIGITALLY FINGERPRINTING DATA STREAMS

(71) Applicant: SURVEYMONKEY INC., Palo Alto, CA (US)

(72) Inventors: ABHINAV AGRAWAL, San Carlos, CA (US); ARJUN LALL, San Francisco, CA (US); JASON TOMLINSON, San Francisco, CA (US)

(21) Appl. No.: 14/978,087

(22) Filed: Dec. 22, 2015

(51) Int. Cl. H04L 29/08; H04L 12/26

(52) U.S. Cl. CPC H04L 67/22; H04L 43/045; H04L 43/065

(57) ABSTRACT

A method for tracking user activity includes receiving, at an analysis computer, data being accessed by a user computing device, identifying unique patterns in the data using the analysis computer, comparing the unique patterns in the data to a repository of unique patterns to identify a user application receiving the data, tracking user activity in the user application on the analysis computer when the unique pattern corresponds to a user application, creating a report of the user activity, and displaying the report on a user interface of the user computing device.

### BACKGROUND

With the proliferation of smart phones and users' ability to access and interact with providers' websites, data and services, many advantages exist in tracking these events. Many providers track the users in their systems and use that information to improve their services, as well as to market related services to the users. This typically occurs on a site-by-site, application-by-application basis, with the tracking performed by the provider's servers remote from the user's phone, table or other user device.

Users may also subscribe to tracking services, such as phone trackers, etc., but these again are one at a time services. Currently, no applications or systems exist that track a user's activity at the user's phone or device level, gathering information about the user's activity across several different applications.

### BRIEF DESCRIPTION OF THE DRAWINGS

FIG. 1 shows an embodiment of a system in which user's applications are tracked using digital fingerprints.

FIG. 2 shows flowchart of an embodiment of a method of tracking user data by analyzing user data for unique data patterns.

FIGS. 3-4 show embodiments of user interfaces through which user activity reports can be transmitted to a user.

FIG. 5 shows a flowchart of a method of building a repository of unique data patterns for applications.

### DETAILED DESCRIPTION OF THE EMBODIMENTS

In the following discussion, a ‘user device’ or ‘mobile user device’ means any device capable of executing an application or an ‘app.’ The user device has the capability to run software code downloaded to a memory on the device and a processor that can operate the software code. The software code may take the form of an ‘application.’ An application is a set of software code that allows an end user to perform a specific task.

Applications may be provided by a particular company that provides a service, such as airlines, travel booking sites, banks, etc. The application allows the user to interact with those providers' systems to perform tasks. Other applications may allow the user to perform tasks local to their phone, with an optional service offered optionally to the user, such as games, exercise and other personal use apps, etc. These consist of only two examples of a myriad of applications available to users for their mobile devices.

The embodiments here provide a process and system for tracking a user's user of application on his or her mobile device. As a user accesses or ‘launches’ applications, the system identifies the application and begins tracking its use. Tracking may encompass many different parameters such as elapsed time, number of accesses, amount of data uploaded or downloaded, locations of access, etc. For applications that provide access to downloaded files, such as movies, books, videos on services such as YouTube™, documents, etc., the tracking may include identification of the files downloaded.

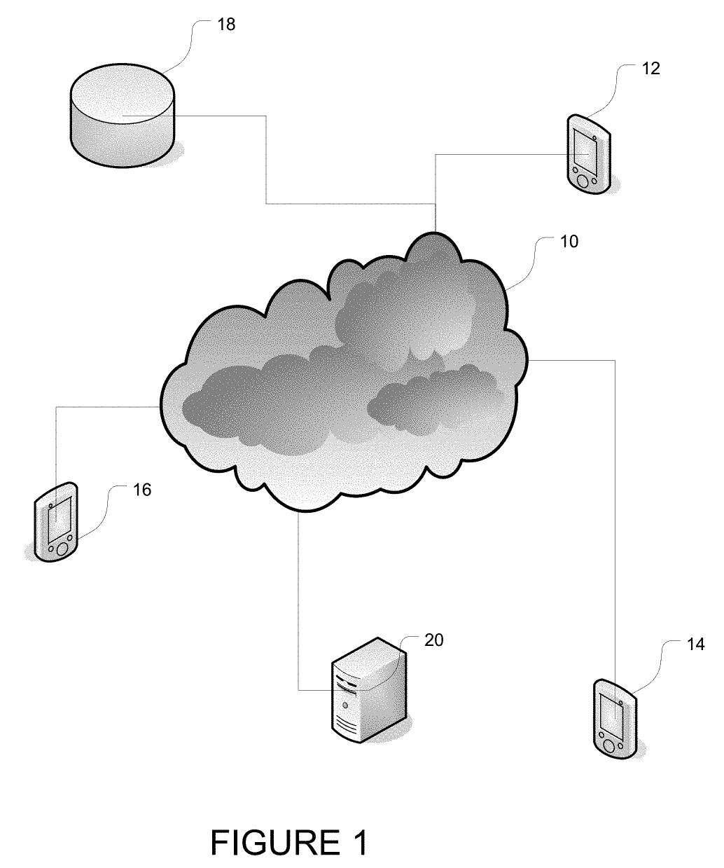

FIG. 1 shows an example of a network in which a user's device resides. The network includes the network infrastructure 10, which may be a packet-switched network such as the Internet, cellular network, or both. The user device may interact with the network through the packet-switched network, the cellular network, or both. The embodiments here operate on the application usage on the individual user devices. The system transmits data across the network, regardless of the type network. Embodiments here function independent of the type of network.

User devices such as 12, 14 and 16 may consist of smart phones, tablets, computers, etc. In the embodiments here, a server such as 20 may provide the user device with a tracking application that tracks the user's interactions with the applications on the user's device. The applications with which the user interacts will be referred to as user application to differentiate them from the tracking application. The tracking may include the amount of time the user is using the application, the amount of data transferred, etc. The tracking may occur on the user's device, the server or elsewhere in the system.

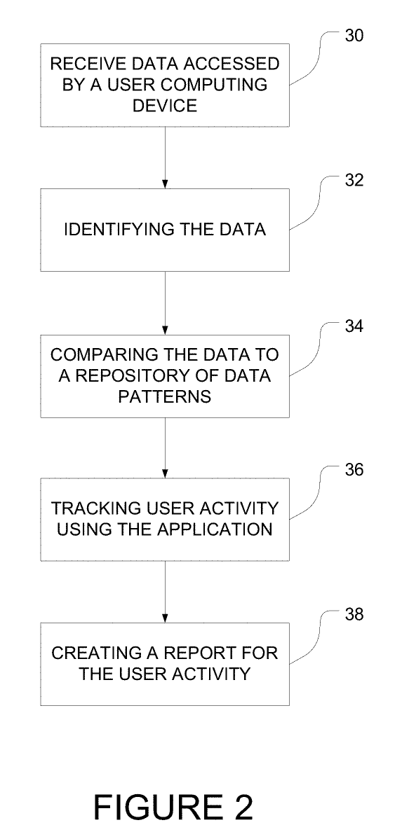

As discussed with reference to FIG. 2, the process receives data being accessed by the user device at 30. Rather than query the user as to what the data is related, or limit the data stream to the data for a particular application, the process receives all of the data coming into the device at 30. The process looks at the incoming data and identifies a unique pattern in the data at 32. The system, an embodiment of which is shown in FIG. 1, has a repository of unique data patterns each associated with one of many applications. The data pattern, or digital fingerprint, on the user device is compared to the patterns in the repository. This identifies the application associated with the data pattern, and allows the system to track the amount of time the user interacts with that application at 36, the amount of data used, etc.

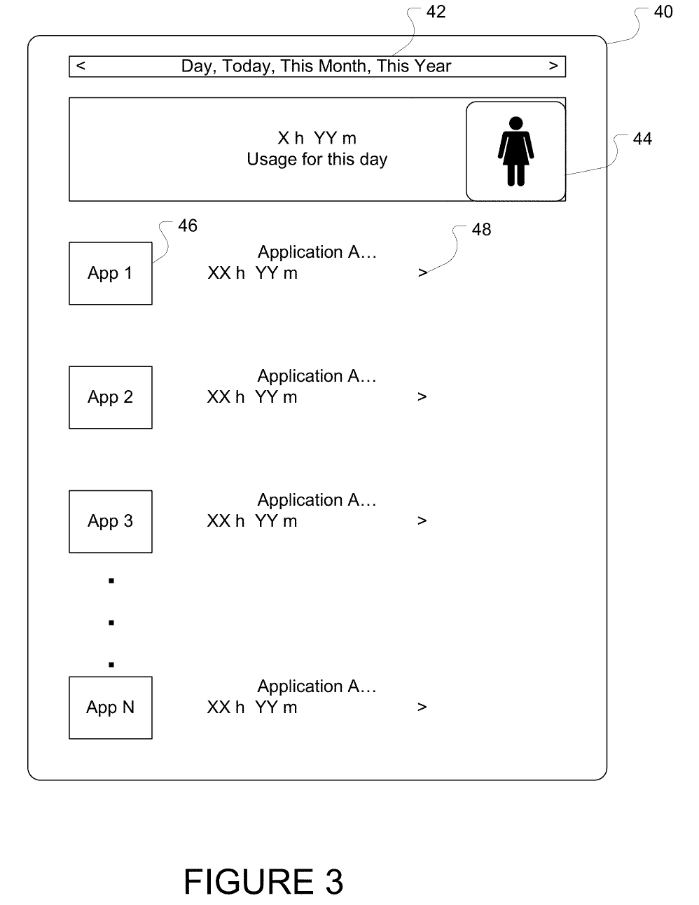

Once the information is gathered, which may occur on an ongoing basis, a report is created at 38. One should note that creation of the report may consist of updating an already present report. FIG. 3 shows one embodiment of a user interface through which the users receives a report generated by the tracking application.

The user interface 40 shows one embodiment of a report provided to a user on that user's usage of different applications. The user interface 40 may consist of several different components, the parts shown here merely provide an example. Since tracking will more than likely occur by time, a banner 42 may display the day of the week (Day), the date (Today), the month (This Month) and the year (This Year).

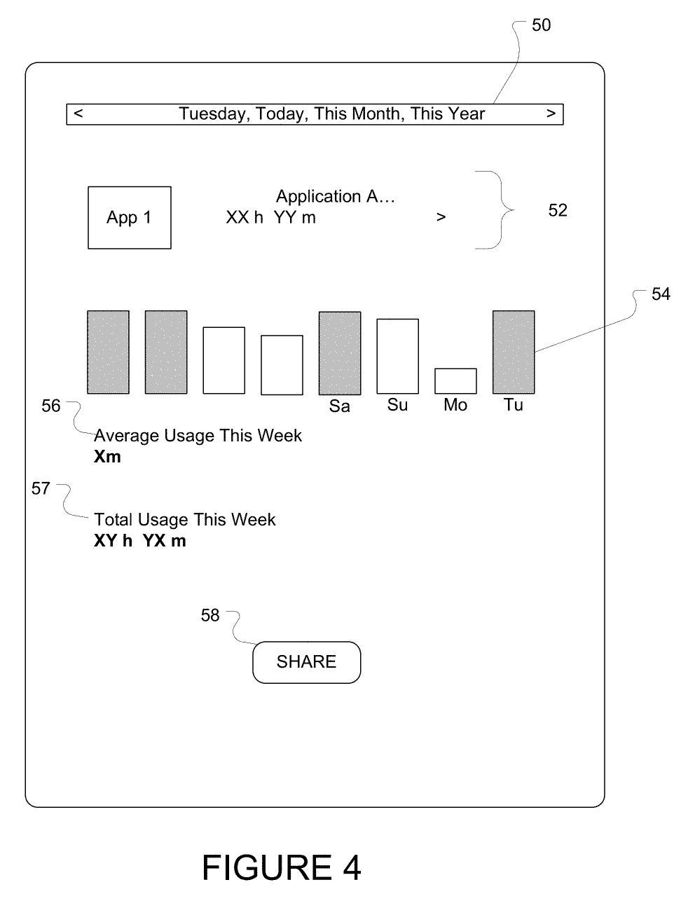

In the embodiment of FIG. 3, a daily summary 44 shows the amount of application usage for that day across all of the applications. Below the daily summary is a summary of usage for each application and the associated time used for each application such as 46. The tracking shown here is by time, but may also be tracked by data downloaded or uploaded, etc. If the user wants to see more detail about the application, the user can select the expansion arrow 48. FIG. 4 shows an embodiment of a user interface showing an expanded view for a particular application.

In the embodiment of FIG. 4, the banner 50 shows the current day as in the user interface 40 from FIG. 3. This particular view is for App 1 from the previous user interface, shown by the identifier 52. The amount of time shown may consist of the time for the day, as shown, or may consist of the amount of time for some other period. The graph 54 shows one example of tracking usage across a week, in a day by day bar graph. Many other types of graphs would also be possible. Report elements 56 show the average usage per day for the week, and element 57 shows the total usage over the week 57. As the user may want to share their usage with others, there may be connectors such as 58 for social media applications, such as Facebook®, Twitter®, etc.

The tracking, whether shown by time or usage, is possible because the user data is tracked by the system, more than likely with a tracking application as mentioned above. In one embodiment, the user agrees that their data will travel through a virtual private network (VPN) when accessing applications. This provides the system with the ability to capture and analyze the data as needed to determine usage at an analysis computer such as the server 20 from FIG. 1. The data between the application on the user's device and the service provider's website may travel through the VPN, or the user's data just from the user's device may travel through the VPN.

For some platforms, where a platform is a combination of a user device and operating system, the data may be accessed directly by the tracking application and sent to the analyzing computer across the network. This would not involve a VPN.

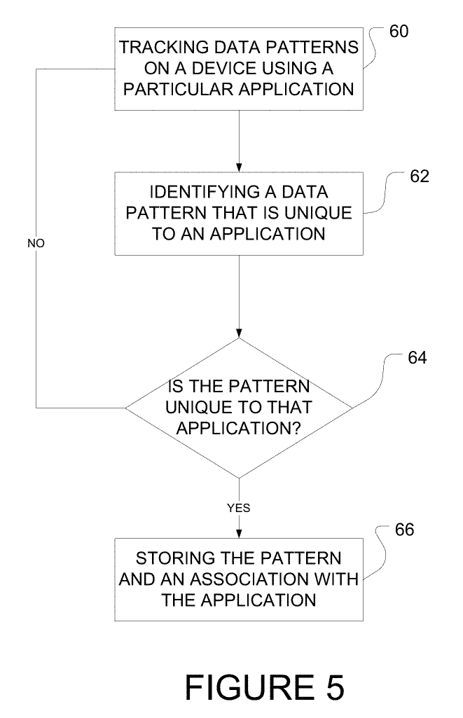

Once captured, the system analyzes the data and identifies the application, typically at an analyzing computer, such as the server 20 from FIG. 1. The analyzing computers may be distributed at different locations or the analysis may be spread among several computers at one location. The method ideally can make this identification without any interaction or requirements on the user. In one embodiment, the system may run several different devices and access many different applications with each device. The system uses the data streams to identify unique patterns in the data associated with each application to build the repository later used in analysis. FIG. 5 shows an embodiment of this process.

At 60, the system tracks data patterns on the device as the device users a particular application. The system then identifies a particular data pattern that appears to be unique to that application at 62, referred to here as the application fingerprint. The unique pattern for an application may be thought of as a digital fingerprint for that application, which is a unique combination of bytes that only arises from use of that application.

With the large amounts of data, it is possible that a pattern may not be unique, it may be that another application has just not given rise to that particular pattern yet. The system then test the pattern at 64 against a repository of patterns at 64. If another application corresponds to that pattern the process returns to 60 and the tracking continues. If no other application corresponds to that pattern, the system stores the pattern and an identifier for its corresponding application in the repository.

The repository then has at least two functions. During operation of the application that tracks usage, the repository allows the incoming data from the user device to be identified as corresponding to a particular application. During the fingerprinting of a new application, the repository allows the system to double check the results and ensure that the applications are associated with unique data patterns. For example, a new application undergoes testing and the system thinks it has identified a unique data pattern. It then checks it against the repository. If it determines that the pattern is not unique, not only does the new application need to continue analysis, the previously stored application must be re-analyzed to arrive at a new fingerprint for that application, as the fingerprint is no longer unique.

In order to build the repository, the system may monitor newly available applications on some periodic basis, then download them to at least one of many ‘laboratory’ user devices. The laboratory devices run the applications while the system analyzes the data to identify the unique pattern in the data for that application. This allows the repository to be updated with new applications and their fingerprints without having to wait for a user to download and run the applications. The number of laboratory devices may be increased as needed to accommodate large numbers of applications waiting to be fingerprinted. This process focuses on the building of the repository, allowing the tracking application to identify more applications in use on the user devices.

In this manner, the system can identify usage of applications on a user device with little or no interaction required from the user. Further, the report generated may be presented to the user, so the user can see the results, rather than just making the results available to the providers as typically occurs now. The ability for a user to see his or her own usage on an application by application basis is not provided by any other systems.

While the embodiments above have mostly concentrated on providing the report of usage activity to the user, one should note that the usage reports may also be sent to the application providers, service providers, network providers, etc. The reports may be formatted differently, such as usage of an application across multiple users for a period of time being provided to the application provider/author. Many other options and modifications exist.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-implemented method for tracking user activity, comprising:
receiving, at an analysis computer, data being accessed by a user computing device;
identifying unique patterns in the data using the analysis computer;
comparing the unique patterns in the data to a repository of unique patterns to identify a user application receiving the data;
tracking user activity in the user application on the analysis computer when the unique pattern corresponds to a user application;
creating a report of the user activity; and
displaying the report on a user interface of the user computing device.

2. The computer-implemented method of claim 1, further comprising providing the report to an application provider.

3. The computer-implemented method of claim 1, wherein receiving data being accessed by the user computing device comprises receiving data transmitted across a virtual private network to the analysis computer.

4. The computer-implemented method of claim 1, wherein receiving data being accessed by the user computer device comprising receiving data from an application programming interface associated with a tracking application.

5. The computer-implemented method of claim 1, wherein identifying unique patterns in the data comprises identifying a particular pattern of bytes in the data.

6. The computer-implemented method of claim 1, wherein comparing the unique patterns in the data to a repository comprises:
tracking data patterns on several devices running several different user applications;
identifying a data pattern that is unique to a user application;
checking that the data pattern is unique to the user application; and
storing the pattern and an identifier of the associated application in the repository when the data pattern is unique to allow comparison of incoming user data to data in the repository.

7. The computer-implemented method of claim 6, further comprising:
determining that the data pattern is not unique by matching the data pattern to an existing data pattern associated with a different user application in the repository;
continuing to analyze data patterns; and
updating the existing data pattern for the different user application and the unique data pattern for the user application in the repository.

8. A computer-implemented method of building a repository of digital fingerprints, comprising:
executing a user application on at least one user device;
analyzing data generating during execution of the user application to identify a unique pattern in the data;
associating the unique pattern in the data with the user application; and
storing the unique pattern in the data and an identifier of the user application in a repository.

9. The computer-implemented method of claim 8, further comprising:
determining that the data pattern is not unique by matching the data pattern to an existing data pattern in the repository for a different application;
continuing to analyze data patterns; and
updating the existing data pattern in the repository to a new unique data pattern for the different application and for the user application.

10. The computer-implemented method of claim 8, wherein executing a user application comprises executing multiple user applications on multiple user devices in a laboratory.
